(19) United States
(12) Patent Application Publication
(10) Pub. No.: US 2009/0013594 A1
(43) Pub. Date: Jan. 15, 2009

(54) Lawn care device

(76) Inventor: Jeffery J. Gadomski, Rochester, NY (US)

Correspondence Address: JAMES RAY & ASSOCIATES, 2640 PITCAIRN ROAD, MONROEVILLE, PA, 15146, US

(21) Appl. No.: 12/214,630

(22) Filed: Jun. 20, 2008

Related U.S. Application Data
(60) Provisional application No. 60/948,826, filed on Jul. 10, 2007.

(51) Int. Cl. A01B 1/24; A01D 46/00

(52) U.S. Cl. 47/1.43; 56/329; 294/165

(57) ABSTRACT

A lawn care device includes a first generally flat member. A second generally flat member is hingedly connected along a first predetermined side edge thereof to a first predetermined side edge of such first generally flat member. A third generally flat member is hingedly connected along a first predetermined side edge thereof to a second predetermined side edge of such first generally flat member. An aperture is formed closely adjacent to a predetermined top edge of such first generally flat member and disposed therethrough. A first cut out portion is formed along a second predetermined side edge of such second generally flat member for alignment with such aperture. A second cut out portion is formed along a second predetermined side edge of such third generally flat member for alignment with such aperture.

### CROSS REFERENCE TO RELATED APPLICATION

This patent application is related to and claims priority from U.S. Provisional Patent Application Ser. No. 60/948,826 filed Jul. 10, 2007.

### FIELD OF THE INVENTION

The present invention relates, in general, to lawn care devices and, more particularly, this invention relates to devices for collecting lawn debris and cuttings.

### BACKGROUND OF THE INVENTION

Prior to the conception and development of the present invention, lawn care devices, as are generally well known in the prior art, have been used to care for lawns. Typically pruning and cutting devices are used to trim branches and greenery from trees and shrubs. The cuttings and clippings and debris generally fall to the ground resulting in more work in the form of collecting and removing the debris and cuttings. Furthermore the cuttings, clippings, and debris may fall onto a lawn, garden, flowerbed, mulch, and stones which then may be damaged or disturbed. Cleaning up may be even more time-consuming and difficult than the trimming.

Specifically of interest to the present invention are the following:

Andrews, U.S. Pat. No. 4,703,615 discloses a portable multi-use receptacle. The device is particularly useful as a receptacle for collecting and holding tree and shrub trimmings or leaves. The device consists of a basin-like structure having a flat rigid base. The base has an outer wall attached to the periphery thereof. The outer base has an opening therein between about ⅛ and about ⅓ of the periphery. The base has a second substantially shorter wall bridging the opening of the first wall along the periphery of the base. The base has a third wall corresponding approximately in height to the second wall. The third wall extends inward from one juncture of the first and second walls to the center portion of the base and then outward to the other juncture of the first and second walls. In this manner a walled, wedge-shaped section is defined in the base.

Glisan, U.S. Pat. No. 4,761,944 discloses a bush trimming catcher designed to be positioned around a bush and to catch trimmings cut from the limbs of the bush. The catcher is formed from nylon or light canvas material which is supported by plastic or light metal tubing. It is expandable in an accordion-like manner to accommodate the size of the bush being trimmed.

Hoheisel, U.S. Pat. No. RE36,775 discloses a collection tarpaulin comprised of top and bottom sheets. The top sheet partially overlies the bottom sheet. Contiguous portions of their respective peripheries are joined together to form a pouch and an exposed portion of the bottom sheet. Trimmings from a tree or bush fall onto the exposed portion of the bottom sheet. By lifting the free end of the bottom sheet, the trimmings slide by gravity into the pouch for disposal.

Osborn, U.S. Pat. No. 4,580,372, discloses a tarpaulin constituted of a fiber-reinforced thermoplastic film material, which incorporates corner or edge grommet structure and weighted components detachably fastenable to the structure so as to ensure that the tarpaulins will not be displaced or carried off in response to extraneous forces caused by the elements, while concurrently allowing for the easy handling thereof during use, particularly when employed for outdoor purposes, such as the accumulation and removal of lawn trash constituted of leaves, grass or shrubbery cuttings and the like.

Furmaga, U.S. Pat. No. 4,539,800 discloses a part circle metal frame having a mat secured thereto which is centrally foldable about a skid bar for catching shrub trimmings in an unfolded position beneath a shrub, for removing the shrub trimmings from beneath the shrub on the skid bar and for transporting the shrub trimmings to a refuge container with the frame and mat folded to form a pouch having a rigid frame.

### SUMMARY OF THE INVENTION

The present invention provides a lawn care device including a first generally flat member manufactured from a first predetermined material and having a first predetermined size and a first predetermined shape. A second generally flat member is hingedly connected along a first predetermined side edge thereof to a first predetermined side edge of such first generally flat member, such second generally flat member is manufactured from a second predetermined material and has a second predetermined size and a second predetermined shape. A third generally flat member is hingedly connected along a first predetermined side edge thereof to a second predetermined side edge of such first generally flat member, such third generally flat member is manufactured from a third predetermined material and has a third predetermined size and a third predetermined shape. An aperture having a fourth predetermined shape is formed closely adjacent to a predetermined top edge of such first generally flat member and disposed therethrough. A first cut out portion is formed along a second predetermined side edge of such second generally flat member for alignment with such aperture. Such first cut out portion has a fifth predetermined size and a fifth predetermined shape. A second cut out portion is formed along a second predetermined side edge of such third generally flat member for alignment with such aperture. Such second cut out portion has a sixth predetermined size and a sixth predetermined shape.

### OBJECTS OF THE INVENTION

It is, therefore, one of the primary objects of the present invention to provide a device which is capable of being placed below at least a predetermined portion of at least one of a tree, a shrub, a bush, a plant and a combination thereof for catching at least one of clippings, trimming, and debris is when such predetermined portion is at least one of cut, trimmed, clipped, and a combination thereof.

Another object of the present invention is to provide a device for enabling a user to easily clean up after trimming a bush, shrub, tree or the like.

Still another object of the present invention is to provide a means for transporting clippings, trimmings, leaves, sticks, debris and the like.

Yet another object of the present invention is to provide an easy to carry device which is flexible and can aid a user in cleaning up a yard or lawn.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which such second generally flat portion and such third generally flat portion are partially folded.

FIG. 3 is a partial perspective view of the invention according to one embodiment of the invention in which such second generally flat portion and such third generally flat portion are folded inward such that such first and second cut out portions are aligned with such aperture.

FIG. 4 is a partial perspective view of the invention according to one embodiment of the invention in which the device has been placed underneath shrubbery to catch clippings, cuttings, debris, leaves, branches, and a combination thereof as such shrubbery is being trimmed.

FIG. 5 is a partial perspective view of the invention according to one embodiment of the invention in which the invention includes a flap type member attached thereto having hook and loop type securing means and the flap type member is depicted in an open position.

FIG. 6 is a partial perspective view of the invention according to one embodiment of the invention in which the invention includes a flap type member attached thereto and such flap type member is depicted in a closed position.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

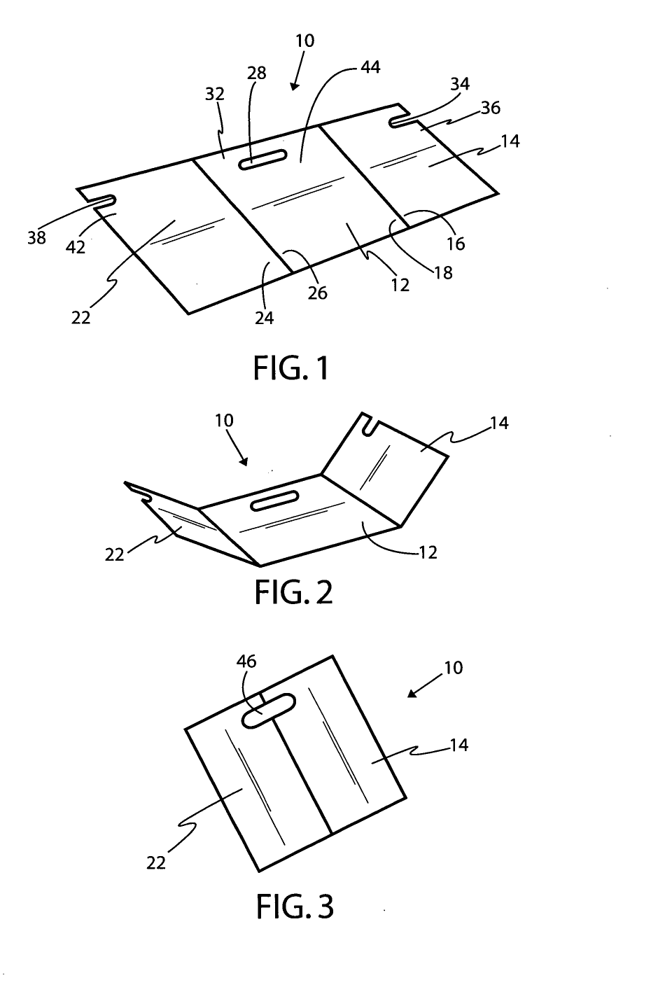

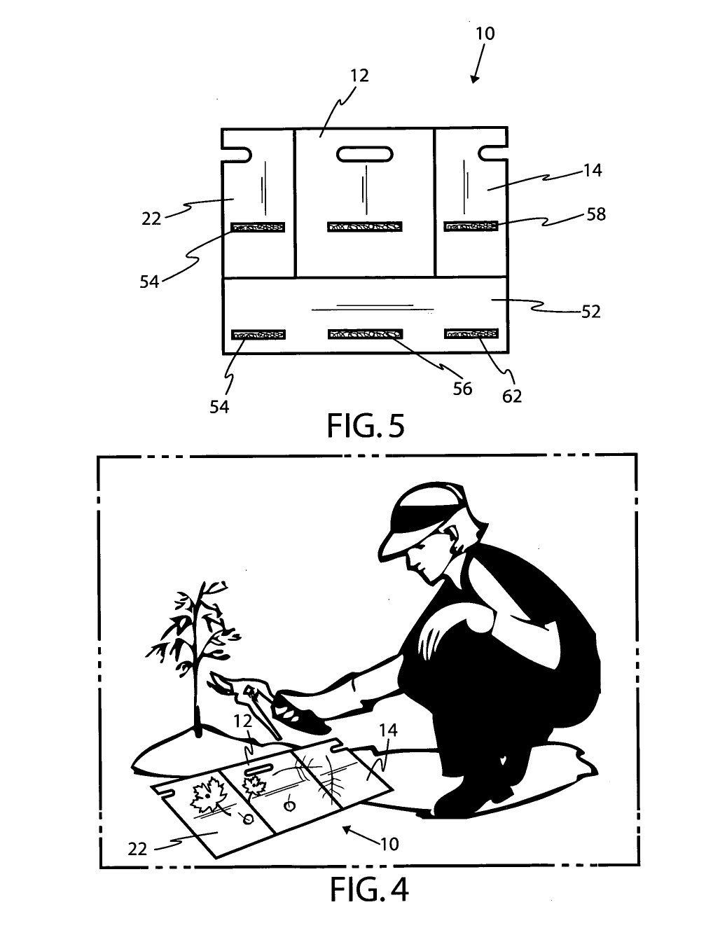

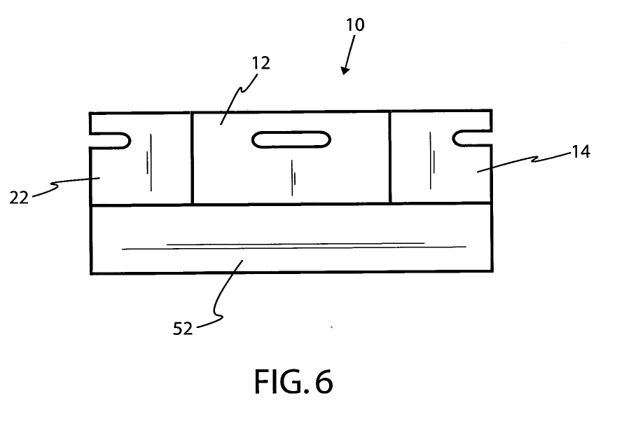

Reference is now made, more particularly, to FIGS. 1-6.

A lawn care device, generally designated 10, is provided. A first generally flat member 12 is manufactured from a first predetermined material and has a first predetermined size and a first predetermined shape. It is presently preferred that such first predetermined size is between about 22.0 inches by about 38.0 inches.

A second generally flat member 14 is hingedly connected along a first predetermined side edge 16 thereof to a first predetermined side edge 18 of such first generally flat member 12. Such second generally flat member 14 is manufactured from a second predetermined material and has a second predetermined size and a second predetermined shape. It is presently preferred that such second predetermined size is between about 10.0 inches by about 38.0 inches.

A third generally flat member 22 is hingedly connected along a first predetermined side edge 24 thereof to a second predetermined side edge 26 of such first generally flat member 12. Such third generally flat member 22 is manufactured from a third predetermined material and has a third predetermined size and a third predetermined shape. It is presently preferred that such third predetermined size is between about 10.0 inches by about 38.0 inches.

An aperture 28 having a fourth predetermined shape is formed closely adjacent to a predetermined top edge 32 of such first generally flat member 12 and disposed therethrough.

A first cut out portion 34 is formed along a second predetermined side edge 36 of such second generally flat member 14 for alignment with such aperture 28. Such first cut out portion 34 has a fifth predetermined size and a fifth predetermined shape.

A second cut out portion 38 is formed along a second predetermined side edge 42 of such third generally flat member 22 for alignment with such aperture 28. Such second cut out portion 38 has a sixth predetermined size and a sixth predetermined shape.

It is presently preferred that at least one of such second generally flat member 14, such third generally flat member 22, and a combination thereof is foldable at least one of upwards, inwards, and a combination thereof along each respective hingedly connected edge.

It is presently preferred that such first predetermined material is at least one of plastic, metal, and cardboard. It is presently most preferred that such first predetermined material is plastic. It is presently preferred that such first predetermined material, such second predetermined material, and such third predetermined material are substantially identical.

It is presently preferred that such second generally flat member 14 and such third generally flat member 22 are foldable over a predetermined portion 44 of such first generally flat member 12 such that the first cut out portion 34 and the second cut out portion 38 are alignable with such aperture 28 to form a handle type opening 46.

When such second generally flat member 14 and such third generally flat member 22 are in a completely folded position the device 10 may be carried by such handle type opening 46. When in a partially folded position, the device 10 may be carried by a user 45 grasping such second generally flat member 14 and such third generally flat member 22. Furthermore, such second generally flat member 14 and such third generally flat member 22 may be folded upward and inward for storage purposes or for fitting within a small area.

According to one embodiment of the present invention, when such second generally flat member 14 and such third generally flat member 22 are in an open position and the device 10 is lifted such device 10 may provide rigid support for clippings, cuttings, leaves, branches, debris, and a combination thereof resting upon such device 10.

According to another embodiment, it is presently preferred that such lawn care device 10 further includes a flexible flap member 52 operably connected thereto at a predetermined location thereon for receiving and storing at least one of clippings, cuttings, leaves, branches, debris, and a combination thereof from at least one of a tree, a bush, a shrub, greenery, and a combination thereof.

Such flexible flap member 52 is manufactured from a seventh predetermined material and has a seventh predetermined size and a seventh predetermined shape. It is presently preferred that such seventh predetermined material is at least one of vinyl, fabric, plastic, nylon, canvas, and a combination thereof.

It is presently preferred that such flexible flap member 52 further includes a securing means 54 operably connected to at least one of the flexible flap member 52 and such lawn care device 10 at a predetermined location thereon for securing such flexible flap member 52 in a closed position.

It is presently preferred that such securing means 54 is a hook and loop type securing means 56 having at least one first portion 58 thereof operably disposed at a predetermined location on at least one of such first generally flat member 12, such second generally flat member 14, such third generally flat member 22 and a combination thereof and at least one second mating portion 62 operably disposed on such flap type member 52 at a predetermined location thereon.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A lawn care device comprising;
a. a first generally flat member manufactured from a first predetermined material and having a first predetermined size and a first predetermined shape;
b. a second generally flat member hingedly connected along a first predetermined side edge thereof to a first predetermined side edge of said first generally flat member, said second generally flat member being manufactured from a second predetermined material and having a second predetermined size and a second predetermined shape;
c. a third generally flat member hingedly connected along a first predetermined side edge thereof to a second predetermined side edge of said first generally flat member, said third generally flat member being manufactured from a third predetermined material and having a third predetermined size and a third predetermined shape;
d. an aperture having a fourth predetermined shape formed closely adjacent to a predetermined top edge of said first generally flat member and disposed therethrough;
e. a first cut out portion formed along a second predetermined side edge of said second generally flat member for alignment with said aperture, said first cut out portion having a fifth predetermined size and a fifth predetermined shape; and
f. a second cut out portion formed along a second predetermined side edge of said third generally flat member for alignment with said aperture, said second cut out portion having a sixth predetermined size and a sixth predetermined shape.

2. A lawn care device according to claim 1 wherein at least one of said second generally flat member, said third generally flat member, and a combination thereof is foldable at least one of upwards, inwards, and a combination thereof along each respective hingedly connected edge.

3. A lawn care device according to claim 1 wherein said first predetermined size is between about 22.0 inches by about 38.0 inches.

4. A lawn care device according to claim 1 wherein said second predetermined size is between about 10.0 inches by about 38.0 inches.

5. A lawn care device according to claim 1 wherein said third predetermined size is between about 10.0 inches by about 38.0 inches.

6. A lawn care device according to claim 1 wherein said first predetermined material is at least one of plastic, metal, and cardboard.

7. A lawn care device according to claim 6 wherein said first predetermined material is plastic.

8. A lawn care device according to claim 1 wherein said first predetermined material, said second predetermined material, said third predetermined material are substantially identical.

9. A lawn care device according to claim 2 wherein said second generally flat member and said third generally flat member are foldable over a predetermined portion of said first generally flat member such that said first cut out portion and said second cut out portion are alignable with said aperture to form a handle type opening.

10. A lawn care device according to claim 1 wherein said lawn care device further includes a flexible flap member operably connected thereto at a predetermined location thereon for receiving and storing at least one of clippings, cuttings, leaves, branches, debris, and a combination thereof from at least one of a tree, a bush, a shrub, greenery, and a combination thereof, said flexible flap member being manufactured from a seventh predetermined material and having a seventh predetermined size and a seventh predetermined shape.

11. A lawn care device according to claim 10 wherein said flexible flap member further includes a securing means operably connected to at least one of said flexible flap member and said lawn care device at a predetermined location thereon for securing said flexible flap member in a closed position.

12. A lawn care device according to claim 11 wherein said securing means is a hook and loop type securing means having at least one first portion thereof operably disposed at a predetermined location on at least one of said first generally flat member, said second generally flat member, said third generally flat member and a combination thereof and at least one second mating portion operably disposed on said flap type member at a predetermined location thereon.

13. A lawn care device according to claim 10 wherein said seventh predetermined material is at least one of vinyl, fabric, plastic, nylon, canvas, and a combination thereof.
